(19) United States
(12) Patent Application Publication
(10) Pub. No.: US 2005/0212945 A1
(43) Pub. Date: Sep. 29, 2005

(54) Digital camera

(75) Inventors: Masanobu Shirakawa, Nagano (JP); Shuji Tsuji, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/045,483

(22) Filed: Jan. 31, 2005

Related U.S. Application Data
(63) Continuation of application No. PCT/JP03/09621, filed on Jul. 29, 2003.

(30) Foreign Application Priority Data
Jul. 29, 2002 (JP) P. 2002-219321
Jul. 29, 2002 (JP) P. 2002-219371

(51) Int. Cl. H04N 5/222

(52) U.S. Cl. 348/333.12

(57) ABSTRACT

Not data obtained by synthesizing subject data and background data but the subject data as that are stored in a removable memory and the subject data and the background data are correlated by the associating record; accordingly, the background data that are synthesized with the subject data can be set after the imaging. Furthermore, until a user selects the background data that are correlated with the subject data stored in the removable memory in a step S280, without synthesizing and displaying the subject data and the background data, only the subject data are displayed (step S260). Accordingly, a process necessary for the user to select one of a plurality of background data is less.

### BACKGROUND OF THE INVENTION

The present invention relates to a digital camera.

A digital camera has a use of, for instance, recording data as a material for a composite image. The composite images are widely used for printing greeting cards with photograph, photograph seals with frame and so on.

In JP-A-2001-45352, a digital camera in which composite image data obtained by synthesizing data (background data) expressing frames or backgrounds and data (subject data) expressing subjects are recorded in an external memory is disclosed.

However, according to the digital camera disclosed in JP-A No. 2001-45352, before recording in the external memory, background data and subject data are synthesized; accordingly, after imaging, the background data cannot be altered or newly set.

### SUMMARY OF THE INVENTION

A first object of the invention intends to provide a digital camera that allows setting background data within a short time after imaging, altering the background data after imaging or newly setting the background data.

In order to solve the first object, the invention is characterized by a digital camera comprising:

an imaging unit that prepares subject data based on an output of an image sensor and stores the subject data in a nonvolatile memory;

a background selection unit that displays a plurality of background data to be synthesized with the subject data on a display after imaging and allows a user to select at least one of the plurality of displayed background data;

a synthesis and display unit that reduces the subject data stored in the nonvolatile memory according to the selected background data and synthesizes the reduced subject data and the selected background data to display on the display; and

a background setting unit that stores information that associates the subject data stored in the nonvolatile memory with the selected background data in the nonvolatile memory.

A second object of the invention intends to provide a digital camera that allows setting background data while confirming a composite image after photographing, altering the background data after photographing or newly setting the background data.

In order to solve the second object, the invention is characterized by a digital camera comprising:

an imaging unit that prepares subject data based on an output of an image sensor and stores the subject data in a nonvolatile memory;

a background selection unit that separately synthesizes a plurality of background data to one of the subject data stored in the nonvolatile memory to display on a display and allows a user to select at least one of the plurality of synthesized and displayed background data, in which when the background data is synthesized to the one of the subject data, the background selection unit reduces the one of the subject data according to the background data; and

a background setting unit that stores information associating the subject data stored in the nonvolatile memory with the selected background data in the nonvolatile memory. As a result, according to the digital camera involving the first invention, after photographing, within a short time period, the background data can be set. Furthermore, according to the digital camera involving the second invention, a plurality of background data is separately synthesized to one of the subject data and displayed on a display, and at least one of the plurality of synthesized and displayed background data is selected by a user; accordingly, the user, after the photographing, can set the background data while confirming a synthesized image.

### BRIEF DESCRIPTION OF THE DRAWINGS

FIG. 1 is a flowchart, in a first example according to the present invention, showing a flow of processes for setting correlation between subject data and background data after imaging.

FIG. 2 is a block diagram showing a digital camera according to a first example of the invention.

FIG. 3A is a back view of the digital camera according to the first example of the invention, FIG. 3B being a front view thereof.

FIG. 4 is a schematic diagram showing, in the first example according to the invention, background files recorded in a removable memory.

FIG. 5 is a flowchart, in the first example according to the invention, showing a flow of processes for correlating subject data and background data before imaging and storing the subject data in the removable memory.

FIG. 6 is a schematic diagram for explaining information that correlates the subject data and the background date in the digital camera according to the first example of the invention.

FIGS. 7A through 7D are schematic diagrams showing composite image data displayed on an LCD in the first example according to the invention.

FIG. 8 is a schematic diagram showing processes for synthesizing and displaying the subject data and the background data in the first example according to the invention.

FIG. 9 is a flowchart, in a second example according to the invention, showing a flow of processes for setting correlation between subject data and background data after imaging.

FIGS. 10A and 10B are schematic diagrams showing composite image data displayed on the LCD in the second example according to the invention.

### DETAILED DESCRIPTION OF PREFERRED EMBODIMENTS

Hereinafter, embodiments of the present invention will be explained based on examples.

(First Example)

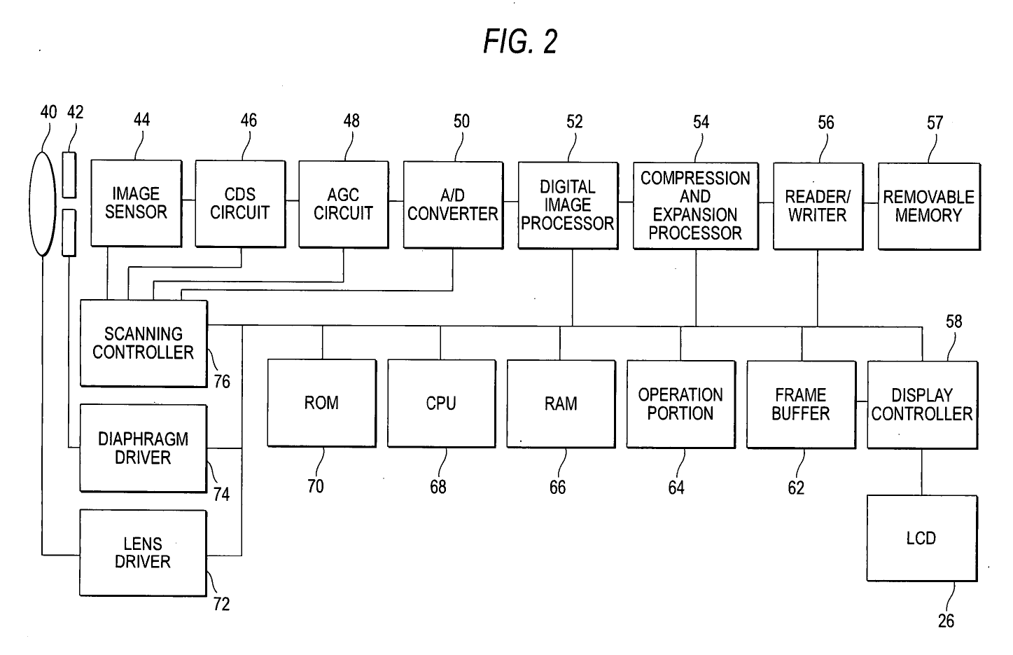

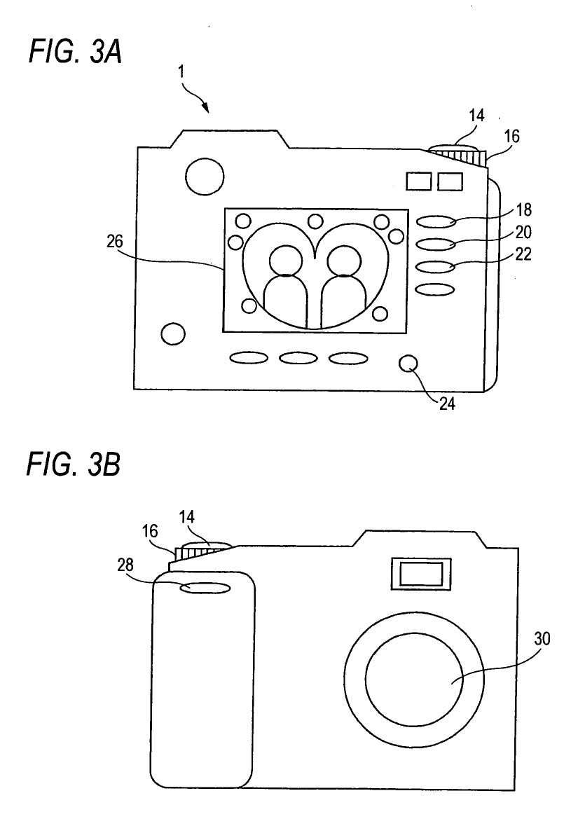

FIG. 2 is a block diagram showing a configuration of a digital camera 1 according to a first example of the invention. FIGS. 3A and 3B are a front view and a back view showing external appearance of the digital camera 1, respectively.

A lens driver 72 drives a zoom lens 40 so that a subject image may be imaged on a receiver of an image sensor 44 at a magnification corresponding to a signal inputted from a CPU 68. A diaphragm driver 74 drives an optical diaphragm 42 so that a quantity of light incident on the image sensor 44 may be a quantity of incident light corresponding to a signal inputted from the CPU 68.

The image sensor 44 is an area image sensor in which a color filter array formed with complimentary filters of four colors of C (Cyan), M (Magenta), Y (Yellow) and G (Green) is formed on-chip, accumulates electric charges generated by photo-electrically converting received light for a definite time period, and outputs an electrical signal corresponding to a quantity of received light for each of photo-electric conversion elements. The color filter array may be formed of complimentary filters of three colors of CMY, or primary color filters of R (Red), G (Green) and B (Blue).

A CDS circuit 46 reduces noise contained in an analogue electrical signal. An AGC circuit 48 controls a level of the analogue electrical signal by controlling a gain. An A/D converter 50 quantizes the analogue electrical signal undergone the above respective processes to a digital signal having a predetermined gradation. A scanning controller 76 outputs, to the image sensor 44, a shift pulse, a vertical transfer pulse, a horizontal transfer pulse and so on, and, to the CDS circuit 46, the AGC circuit 48 and the A/D converter 50, a driving pulse for synchronously actuating these with the image sensor 44.

A digital image processor 52 is constituted of, for instance, a DSP (Digital Signal Processor), carries out, based on an image signal outputted from the A/D converter 50, image generation processing, white balance correction, gamma correction and color space conversion to prepare, for each of pixels, subject data expressing, for instance, gradation values of R, G and B and gradation values of Y, Cb and Cr, and stores these in a RAM 66. The image generation processing here mainly denotes a processing in which, owing to interpolation with digital data expressing any one of gradation values of CMYG corresponding to an output of each of photoelectric conversion elements, image data having four gradation values of CMYG are generated for each of pixels.

A compression and expansion processor 54, in an imaging mode, compresses the subject data outputted from the digital image processor 52 to prepare compressed image data conformed to, for instance, the JPEG format, and, in a reproduction mode, expands compressed image data read from a removable memory 57 by use of a reader/writer 56 to store in the RAM 66. The removable memory 57 constituted from a nonvolatile memory such as a flash memory is freely detachable to the reader/writer 56, and the reader/writer 56 writes data in the removable memory 57 and reads the data stored in the removable memory 57.

An operation portion 64 includes a power source button 14 for performing ON/OFF of a power source; a dial switch 16 for switching mode such as an imaging mode, a reproduction mode and a direct print mode; a shutter button 28 for inputting a shutter instruction; a background setting key 18 for setting a background in the imaging mode; zoom buttons 10 and 12 for setting a magnification of a zoom lens; various kinds of buttons such as a next selection key 20, a precedent selection key 22 and a determination key 24; and a circuit for detecting pushing-down of the buttons and an angle of rotation of the dial switch 16.

A display controller 58 performs a thinning processing where image data outputted from the digital image processor 52 are thinned at a fixed multiplication in accordance with a display region of a display, a color space conversion processing, and a synthesis processing, and drives based on display data prepared by applying the processing a LCD (Liquid Crystal Display) 26 as a display. In a frame buffer 62, there are a background region and a foreground region that separately store image data that are to be synthesized. The display controller 58 includes a synthesis processor that preferentially displays pixels of image data stored in the background region to transparent pixels of image data stored in the foreground region and preferentially displays nontransparent pixels of the image data stored in the foreground region to pixels of the image data stored in the background region, and thereby synthesizes the image data stored, respectively, in the foreground and background regions and displays on the LCD 26.

The CPU 68 carries out a computer program memorized in a ROM 70 and thereby controls an entirety of the digital camera 1. The ROM 70 is a memory for storing a computer program and so on by which the CPU 68 performs various kinds of controls. The RAM 66 is a memory for temporarily memorizing various kinds of programs and data.

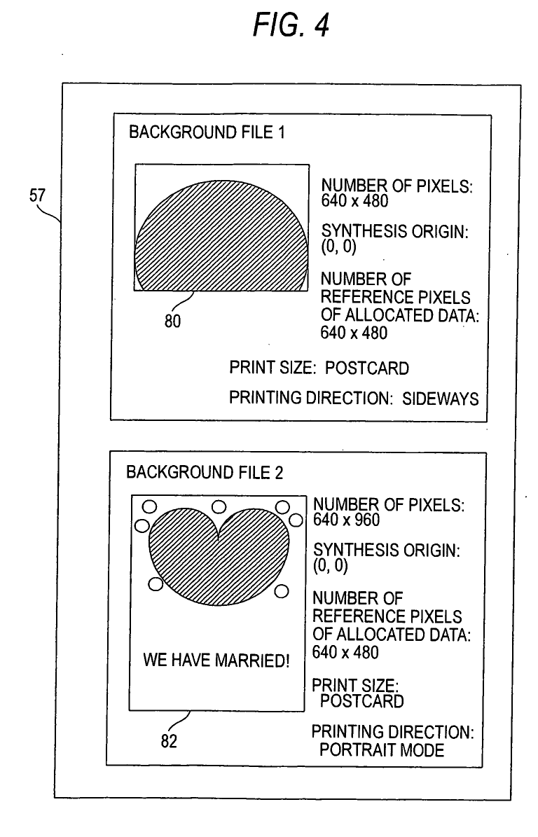

In the above, a constitution of the digital camera 1 was explained. In the next place, background data will be explained. FIG. 4 is a schematic diagram showing background files recorded in the removable memory 57.

The background files are used for preparing printings such as greeting cards with photograph and seals with photograph, transferred from a personal computer and so on, and stored beforehand in the ROM 70 or removable memory 57. Hereinafter, the background files will be explained assuming as stored in a predetermined folder (background folder) of the removable memory 57. The background data stored in the background file denote images 80 and 82 constituted of line drawings, silhouetting, letters and so on. A hatched region is a region where the subject data are fitted in to synthesize (transparent region). For gradation values of the pixels in the transparent region, values expressing the beforehand determined transparency such as R=00H, G=00H, and B=00H are set. The transparent region may be stipulated by a so-called a-channel independent from the respective channels of RGB. In the background data, there are large background data thereto the subject data are partially allocated and small background data to all of which the subject data are allocated. More specifically, at the time of synthesis processing, when an image of an entirety of the subject data and an image of an entirety of background data are superposed, in the large background data the image of an entirety of background data becomes larger than the image of an entirety of the subject data and in the small background data an image of an entirety of background data is equal to or smaller than an image of an entirety of the subject data.

In an image that the small background data express, there is one such as an image 80. In an image that the large background data express, there is one such as an image 82. The small background data expressing the image 80 become, to subject date of, for instance, 640×480 pixels, 640×480 pixels at the synthesis processing. The number of pixels of the large background data expressing the image 82 become, to subject date of, for instance, 640×480 pixels, 640×960 pixels at the synthesis processing. The numbers of pixels of the large background data and the small background data at the synthesis processing are not restricted to the illustrated numbers of pixels; that is, the large background data may be for instance 1600×1200 pixels to the subject data of 640×480 pixels. Furthermore, in a state stored in the removable memory 57, an image size of the background data may not correspond to an image size of the subject data. This is because, at the time of synthesis processing, owing to the thinning or interpolation, the number of pixels can be converted to one corresponding to the image size of the subject data.

The background file is made up of data showing, other than the background data, the number of pixels of the background data, coordinates to which original points of the subject data are corresponded (coordinates of composite origins), the number of reference pixels of allocated data, a print size, and a printing direction (vertical or horizontal) of the background data. At the synthesis processing before printing, the number of reference pixels of the allocated data and the number of pixels of the subject data that are to be allocated are compared, the background data are thinned or interpolated so as to be a magnitude in accordance with the number of pixels of the subject data that are to be allocated, and accordingly coordinates of composite origins are converted.

For instance, when the number of pixels of the background data is (1280×640), coordinates of composite origin are (20, 20), the number of reference pixels of the allocated data is (640×480) and the number of pixels of the subject data is (1280×960), the number of pixels of the subject data is two times the number of reference pixels in both horizontal direction and vertical direction; accordingly, the synthesis processing before the printing is carried out as follows. The background data are interpolated so as to make the number of pixels thereof (2560×1280), coordinates of the composite origin are converted to (40, 40), and the background data and the subject data are synthesized so that the subject data may be superposed in a range from (40, 40) to (1320, 1000) of the converted background data. At the time of printing, based on a print size and a printing direction of the background data stored beforehand in the background file, the interpolation or the thinning or rotation processing is further performed, and thereby a composite image having predetermined print size and printing direction is printed by use of a printer.

In the background file, a position and magnitude of a region on printing paper to which the subject data are allocated may be expressed with parameters such as an upper left coordinate and a lower left coordinate on a region corresponding to, for instance, printing paper. Furthermore, the subject data may be thinned or interpolated in accordance with a magnitude of a region where the subject data are allocated, followed by allocating the thinned or interpolated subject data to a region stipulated by the background file.

Further, when a personal computer or a stand-alone printer is used to synthesize the subject data and the background data followed by printing, and the digital camera 1 and the printer are not assumed to be directly connected to print, true background data that are used to prepare composite image data for use in printing are stored in the personal computer or stand-alone printer, and with one that is lower in the resolution power and more rough in the gradation than the true background data, display processing in the digital camera 1 may be carried out. When thus implemented, a memory space of the digital camera 1 is not overwhelmed by the background data, and the background data can be speedily processed.

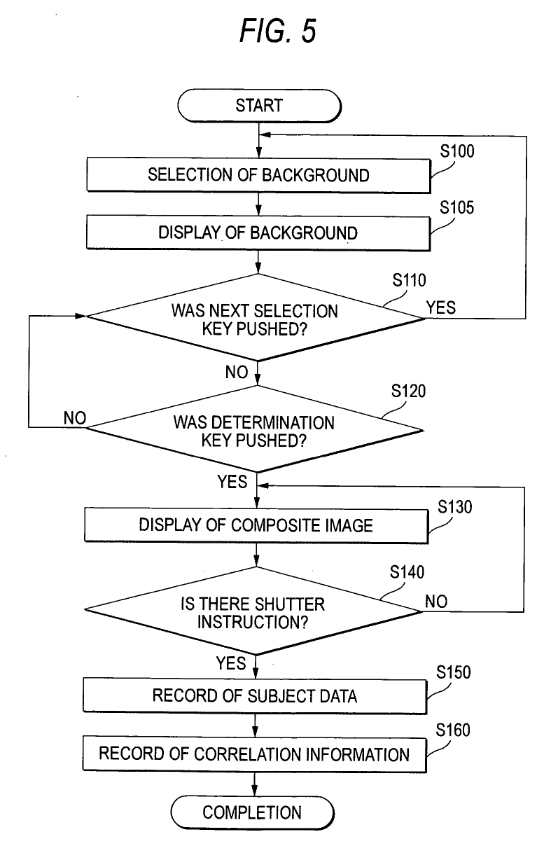

In the above, the background data have been explained. Next, operations of the digital camera 1 will be explained. FIG. 5 is a flowchart showing a flow of processes for correlating the subject data and the background data before imaging and storing the subject data in the removable memory 57. A sequence shown in FIG. 5 starts when an operator pushes down a background setting key 18 in an imaging mode that is determined by an angle of rotation of the dial switch 16.

In a step S100, any one of the background files stored in the removable memory 57 is selected. In a step S105, the background data stored in the selected background file are displayed on an LCD 26. In a step S110, when the next selection key 20 is pushed down, the process returns to the step S100 to select the next background file and the above processes are repeated.

When a determination key 24 is pushed down in a step S120, in a step S130, a subject image is displayed as a moving picture in a transparent region of the background data. Specifically, the background data selected at the steps from S100 to S120 the subject data prepared in the digital image processor 52 are stored in the frame buffer 62. The display controller 58 synthesizes the subject data and the background data stored in the frame buffer 62 and outputs a driving signal to the LCD 26, and thereby as shown in FIG. 3A, a composite image is displayed. When the subject data is renewed every predetermined time interval, the subject data are displayed as a moving picture. Thereby, the subject data can be prepared so as to be in harmony with the background data that are selected by pushing down the determination key 24 in the step S120, that is, at an appropriate composition and timing a shutter instruction can be inputted.

In a step S140, whether the shutter instruction is inputted or not, that is, whether the shutter button 28 is pushed down or not is detected, and when the pushing down of the shutter button 28 is not detected, the process is returned to the step S130 and the above steps are repeated. When the pushing down of the shutter button 28 is detected in the step S140, the process proceeds to a step S150.

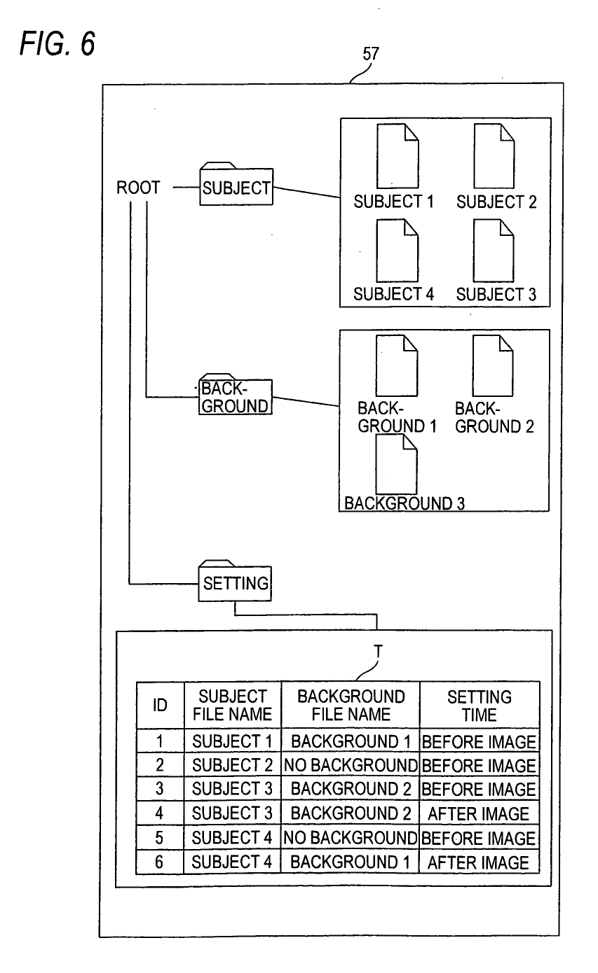

In the step S150, a predetermined control signal is inputted to a scanning controller 76 to scan electric charges stored for a predetermined time in the image sensor 44, subject data are prepared in the digital image processor 52, the subject data are compressed at the compression and expansion processor 54 to prepare compressed image data, and the compressed image data are stored in a predetermined file format such as JPEG by the reader/writer 56 in a subject folder of the removable memory 57 shown in FIG. 6.

In a step S160, information that associates the subject data recorded in the step S150 with the background file selected by pushing down the determination key 24 in the step S110 is stored in the removable memory 57. Specifically, an associating record in which a file name of the subject data recorded in the step S150 is made a “subject file name”, a file name of the background file selected by pushing down the determination key 24 in the step S110 is made a “background file name”, and a “setting time” is made before imaging is prepared and added to a setting table T shown in FIG. 6.

Here, the setting table T that manages the information that associates the subject data with the background data will be explained. The setting table T is recorded in a setting folder of the removable memory 57. The setting table T is made up of an associating record that associates the subject files with the background files on one-on-one level. The respective associating records are made up of an ID, a subject file name, a background file name and a setting time. The “subject file name” is data that clearly discriminate the subject file in which the subject data are stored by the file system such as the digital camera 1 and the personal computer. The “background file name” is data that clearly discriminate the background file by the file system such as the digital camera 1 and the personal computer. The “setting time” is data that show whether the associating record is prepared before the imaging or prepared or edited after the imaging. That is, the associating record in which the “setting time” is before the imaging is the associating record that is prepared in the step S160 and not edited thereafter. The associating record in which the “setting time” is after the imaging is a associating record that is added or overwritten according to a background setting mode described later. By discriminating whether the “setting time” is before the imaging or not, whether a combination of the background data and the subject data that are associated according to the associating record is a combination that is intended by an operator at the time of inputting the shutter instruction and harmonizes the subject and the background or not can be specified. When the shutter instruction is inputted in a state where the background data are not set, a associating record in which “without background” is set in the “background file name” is prepared, and every shutter instruction the associating record may be added every time to a setting table.

In the setting table T, associating records that associate the subject files with the background files in arbitrary combinations can be added without limit up to the upper limit of a memory capacity. Furthermore, an associating record in which, to one subject file, background files different from each other are associated respectively (in an example in FIG. 6, associating records having ID of 3 and 4) can be prepared. Accordingly, by use of the setting table T, information that associates a plurality of background files with one subject file can be stored in the removable memory 57.

The subject data and the background data, without restricting to the table, may be associated through a directory, or the subject files and the background files may be associated by storing a file name of a counterpart in each of the subject files and the background files. Furthermore, an associating file that describes a path of the background file may be recorded for each subject file to associate a file name of the associating file with a file name of the subject file (for instance, file names are partially mated), and thereby the subject data and the background data may be associated.

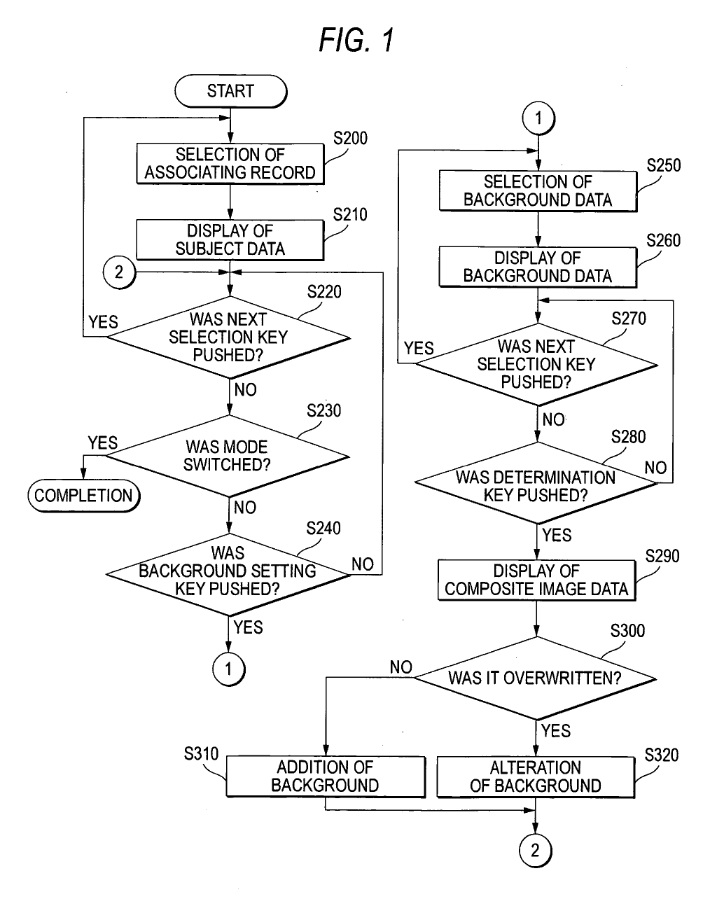

In the next place, a processing for setting correlation between the subject data and the background data after the imaging will be explained. FIG. 1 is a flowchart showing a flow of the processing. A sequence shown in FIG. 1 is started when an operation portion 64 detects an angle of rotation of the dial switch 16 corresponding to a reproduction mode.

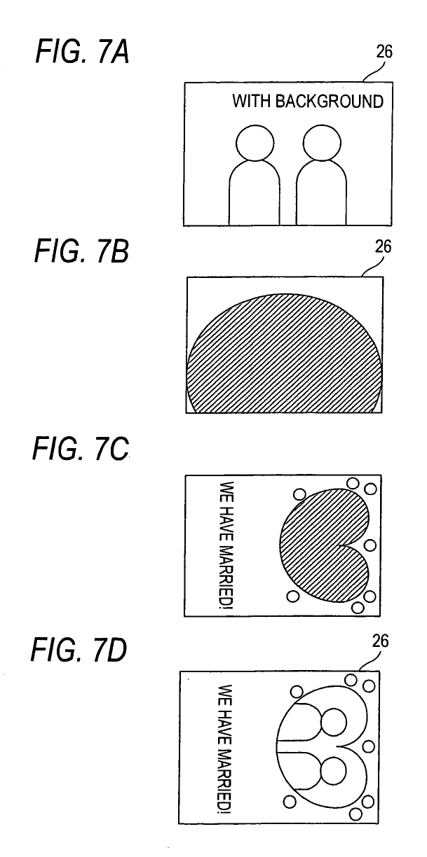

In a step S200, any one of the associating records stored in the setting table T is selected. In step S210, subject data having a subject file name stored in the selected associating record are displayed on the LCD 26. At this time, when, in the selected associating record, the subject file is associated with a background file, letters or an icon showing the relation therebetween is synthesized with a subject as shown in FIG. 7A and displayed. Specifically, the processing is carried out, for instance, as follows. Firstly, the subject data is read by the reader/writer 56 from the removable memory 57, expanded in the compression/expansion processor 54, and stored in the RAM 66. In this explanation, the subject data is assumed as previously compressed and recorded; however, the subject data may be recorded in a non-compressed state. Subsequently, the display controller 58 thins the subject data in accordance with the number of pixels of a display region of the LCD 26 and stores in the frame buffer 62. When the number of pixels of a display region is 320×240 pixels and that of the subject data is 640×480 pixels, the numbers of vertical and horizontal pixels are thinned so as to be one half and stored in the frame buffer 62. The thinning that is carried out here, irrespective of whether the subject data are one that are synthesized with the background data or one that are not synthesized therewith, is a process that is carried out to all of the subject data; accordingly, the thinning is desirably subjected to fast processing by use of an exclusively designed hardware. When, by thinning immediately after the imaging, thumbnail-size image data having the number of pixels same as the display region are recorded in the removable memory 57 together with image data, the thinning carried out here is unnecessary. Subsequently, when the display controller 58, based on the subject data stored in the frame buffer 62, drives the LCD 26, an image that the subject data represent is displayed on the LCD 26.

In a step S220, whether the next selection key 20 is pushed or not is detected. When it is pushed, the process returns to the step S200 to select a subsequent associating record and the above processes are repeated. When the next selection key 20 is not pushed in the step S220, the process proceeds to a step S230 to detect whether a mode switching instruction is inputted or not, that is, whether an angle of rotation of the dial switch 16 is altered or not. When the mode switching instruction is inputted, the reproduction mode is stopped and switched to another mode. When the mode switching instruction is not inputted in the step S230, the process proceeds to a step S240 to detect whether the background setting key 18 is pushed or not. When the background setting key 18 is pushed, the process proceeds to a step S250 and transfers to the background setting mode. A mode for carrying out a sequence of processes from step S250 to step S320 will be called a background setting mode. When the background setting key 18 is not pushed in the step S240, the process returns to the step S220 to repeat the above processes.

In the step S250, any one of the background files stored in the removable memory is selected. In the first processing carried out immediately after the step S240, the background file associated by the associating record selected in the step S200 is selected. In a step S260, the background data stored in the selected background file is displayed in the LCD 26 as shown in, for instance, FIG. 7B. Specifically, the processing is carried out as follows. First of all, the background data are read by the reader/writer 56 from the removable memory 57, expanded by the compression/expansion processor 54, and stored in the RAM 66. In the above explanation, the background data were assumed as previously compressed and recorded; however, the background data may be recorded in a non-compressed state. Subsequently, in accordance with the number of pixels of the display region of the LCD 26, the background data are reduced, and as needs arise the rotation is applied. When the number of pixels of the display region is 320×240 pixels and that of the background data is 640×960 pixels in portrait mode, the numbers of vertical and horizontal pixels are thinned so as to be one third, followed by rotating by 90°, and thereby background data of 320×213 pixels are prepared. The processing, in order to simplify the hardware and to comply with the background data having an arbitrary number of pixels, is desirably carried out according to a program that is carried out in the CPU68. The background data edited for use in display are stored in the frame buffer 62 and, when the display controller 58 drives based thereon the LCD 26, are displayed.

In a step S270, whether the next selection key 20 is pushed or not is detected. When the next selection key 20 is pushed, the process returns to the step S250 to select subsequent background data, the above processes are repeated, and as shown in, for instance, FIG. 7C, the subsequent background data are displayed on the LCD 26. When the next selection key 20 is not pushed, the process proceeds to the step S280 to detect whether the determination key 24 is pushed or not, that is, whether the user selected the background data or not. Until the next selection key 20 or the determination key 24 is pushed, the steps S270 and S280 are repeated, and when the user selected the background data by pushing the determination key 24, the process proceeds to the step S290.

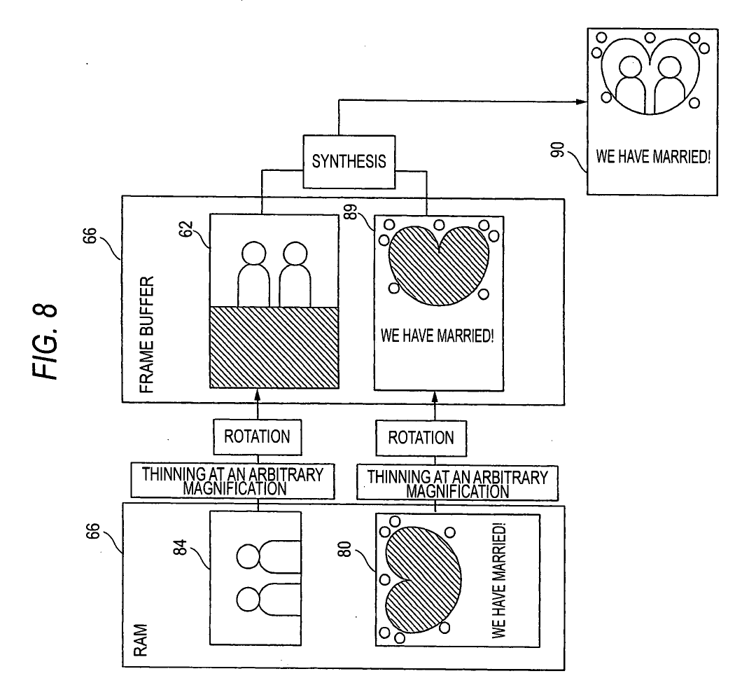

In the step S290, the subject data associated by the associating record that is selected now and the background data selected by the user in the step S280 are synthesized and a composite image shown in, for instance, FIG. 7D is displayed on the LCD 26. Specifically, the processing is carried out as follows. First of all, the background data are read by the reader/writer 56 from the removable memory 57, expanded by the compression/expansion processor 54, followed by storing background data 80 in the RAM 66 as shown in FIG. 8. Subsequently, in order to display an entirety of the background data 80 that are more in the number of pixels than that of the display region in one screen, the reduction in accordance with the number of pixels of the background data 80 and, if necessary, rotation processing is carried out. For instance, when a display region is 320×240 pixels and the background data 80 is 640×960 pixels in a portrait mode, the background data 80 are thinned so that the numbers of vertical and horizontal pixels may be one third, followed by rotating by 90°, and thereby background data 89 for use in print preview of 320×213 pixels are prepared and stored in a foreground region of the frame buffer 62.

In the next place, the subject data stored in the RAM 66 are thinned in accordance with information (such as the number of pixels of the background data, coordinates of a synthesis origin and the number of reference pixels of allocated data) stored in the background file and the number of pixels of the display region, followed by rotating and translating according to coordinate conversion, and thereby subject data 88 for use in print preview are prepared. When subject data 84 are allocated to part of the background data 80, owing to thinning carried out in the step S290 rather than the thinning carried out in the step S210, the magnification becomes smaller. Furthermore, when portrait mode subject data is synthesized with the background data 89 for use in print preview as shown in, for instance, FIG. 8, the subject data 84 stored sideways in the RAM 66 are rotated clockwise by 90°. Furthermore, for instance, in accordance with the coordinate conversion owing to the thinning and the rotation performed to the background data, coordinates of subject data 85 are converted. In an example shown in FIG. 8, from the sideway subject data 84 of 640×480 pixels stored in the RAM 66, the portrait mode subject data 88 for use in print preview of 160×213 pixels are prepared, the subject data 85 for use in print preview are stored in a region corresponding to a right side of screen of the foreground region of the frame buffer 62, and in a region corresponding to a left side of screen a value showing the transparency is stored. Subsequently, the display controller 58 synthesizes the subject data 88 for use in print preview and the background data 89 for use in print preview stored in the frame buffer 62 to output a driving signal on the LCD 26, and thereby an entirety of a composite image for use in print preview is, as shown in, for instance, FIG. 7D, displayed on one screen of the LCD 26.

In a step S300, when information that associates the subject data, associated by the associating record that is now selected, with the background file selected at the step S250 is recorded in the setting table T, the operator is allowed selecting whether the associating record that is now selected is overwritten or a new associating record is recorded. Specifically, for instance, in addition to a letter string of “Do you overwrite?”, buttons of “Yes” and “No” are displayed on the LCD 26, and any one of “Yes” and “No” buttons is selected by the next selection key 20, the precedent selection key 22 and the determination key 24.

When the overwrite is selected in the step S300, the process proceeds to a step S310, the background file name of the associating record that is now selected is altered to a file name of the background selected in the step S250, and the “setting time” of the associating record is altered to “after the imaging”.

When the overwrite is not selected in the step S300, the process proceeds to the step S320, a new associating record in which the subject file name that is now selected is altered to a “subject file name”, the file name of the background data selected in the step S250 is altered to a “background file name”, and the “setting time” is altered to the “after the imaging” is prepared and added to the setting table T. The associating record added at this time corresponds to second associating data described in claim. When the processing of the step S310 or the step S320 comes to completion, the process returns to the step S220 and the above processes are repeated.

In the above, a process of setting association of the subject data with the background data after the imaging was explained. In the first example, an imaging unit described in claims include a CDS circuit 46, an AGC circuit 48, an A/D converter 50, a digital image processor 52, a RAM 66, a compression and expansion processor 54 and a reader/writer 56, and a function thereof is realized by a process of the step S150. A background selection unit described in claims include a frame buffer 62, a display controller 58, a background setting key 18, a next selection key 20, a precedent selection key 22 and a determination key 24, and a function thereof is realized by processes of steps S250 through S280. A synthesis and display unit described in claims includes a frame buffer 62 and a display controller 58, and a function thereof is realized by a process of the step S290. A background setting unit described in claims include a CPU 68, a RAM 66 and a reader/writer 56, and a function thereof is realized by the steps S310 and S320.

In the first example explained above, not data obtained by synthesizing the subject data and the background data but the subject data as that are stored in the removable memory 57, and the subject data and the background data are associated by the associating record that is stored in the setting table T; accordingly, the background data that are synthesized with the subject data can be set after the imaging. Furthermore, in the first example, until the user selects the background data that are associated with the subject data stored in the removable memory 57 in the step S280; without synthesizing the subject data and the background data and displaying, only the subject data are displayed. A throughput necessary for synthesizing the subject data and the background data and displaying is larger than a throughput necessary for displaying only the subject data. In particular, when processes such as the reduction, rotation and parallel translation of the subject data are necessary to synthesize and display, a throughput necessary for synthesizing the subject data and the background data and displaying is far larger than a throughput necessary for displaying only the subject data. In the first example, as mentioned above, until the background data associated with the subject data stored in the removable memory 57 is selected by the user in the step S280, without synthesizing the subject data and the background data and displaying, only the subject data are displayed; accordingly, a throughput necessary for the user to select one of a plurality of background data is less. Accordingly, according to the first example, the user can set the background data in a short time after the imaging.

(Second Example)

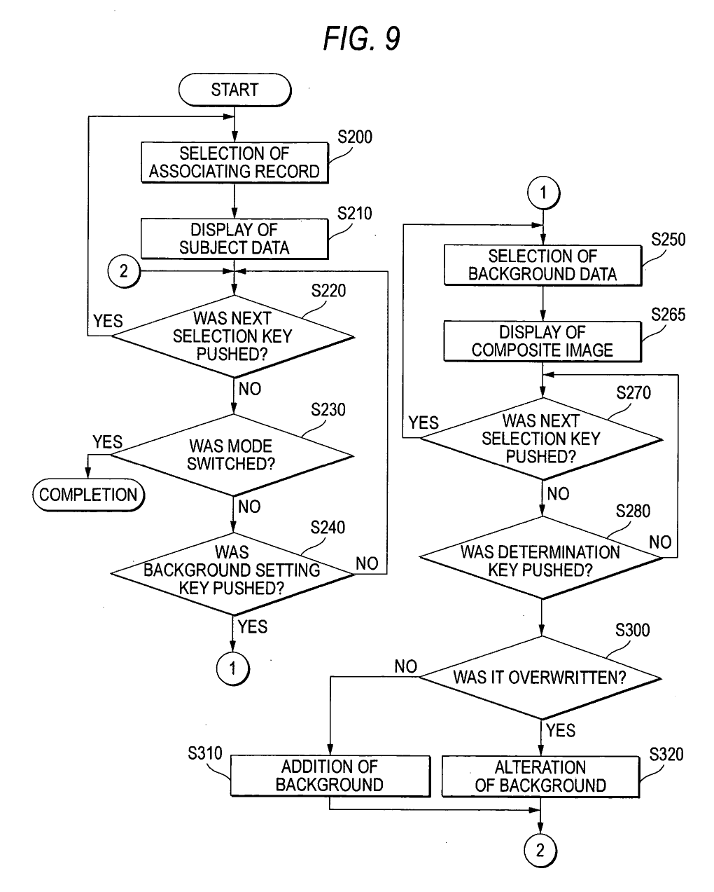

FIG. 9 is a flowchart, in a second example according to the invention, showing a flow of processes for setting association of subject data with background data after imaging. In the processes same as that of the first example, same reference numerals are imparted and explanations thereof are omitted.

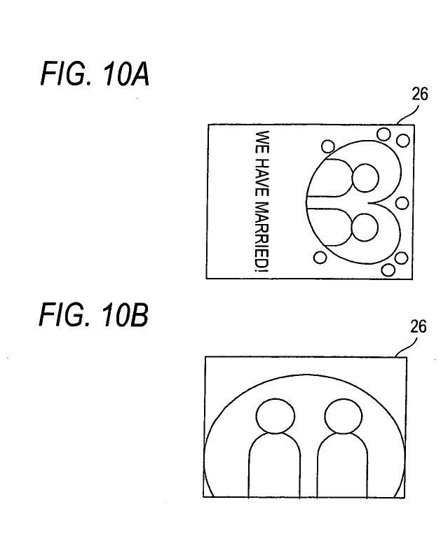

In a step S265, subject data associated according to a associating record that is now selected and background data selected in a step S250 are synthesized and a composite image shown in, for instance, FIG. 10A is displayed on an LCD 26. Specifically, a process same as that of, for instance, the step S290 in the first example is carried out.

In a step S270, whether a next selection key 20 is pushed or not is detected. When the next selection key 20 is pushed, the process returns to the step S250 to select next background data and the above processes are repeated, and, as shown in, for instance, FIG. 7B, next background data and the already selected subject data 84 are synthesized and displayed on an LCD 26. When the next selection key is not pushed, the process proceeds to the step S280 and whether a determination key 24 is pushed or not, that is, whether a user selected the background data or not is detected. Until the next selection key 20 or the determination key 24 is pushed, the steps S270 and S280 are repeated, and when the user pushes the determination key 24 to select the background data the process proceeds to a step S300.

In the second example according to the invention explained above, not data obtained by synthesizing the subject data and the background data but the subject data as that are stored in the removable memory 57, and the subject data and the background data are associated by the associating record that is stored in the setting table T; accordingly, the background data that are synthesized with the subject data can be set after the imaging. Furthermore, in the second example according to the invention, to one subject data, with a plurality of background data replacing in accordance with push down of the next selection key 20, the subject data and the background data are synthesized and displayed on a display, and the user selects at least one of a plurality of synthesized and displayed images; accordingly, the user, after the imaging, with an image after the synthesis confirming, can set the background data.

1. A digital camera comprising:
an imaging unit that prepares subject data based on an output of an image sensor and stores the subject data in a nonvolatile memory;
a background selection unit that displays a plurality of background data to be synthesized with the subject data on a display after imaging and allows a user to select at least one of the plurality of displayed background data;
a synthesis and display unit that reduces the subject data stored in the nonvolatile memory according to the selected background data and synthesizes the reduced subject data and the selected background data to display on the display; and
a background setting unit that stores information that associates the subject data stored in the nonvolatile memory with the selected background data in the nonvolatile memory.

2. A digital camera comprising:
an imaging unit that prepares subject data based on an output of an image sensor and stores the subject data in a nonvolatile memory;
a background selection unit that separately synthesizes a plurality of background data to one of the subject data stored in the nonvolatile memory to display on a display and allows a user to select at least one of the plurality of synthesized and displayed background data, in which when the background data is synthesized to the one of the subject data, the background selection unit reduces the one of the subject data according to the background data; and
a background setting unit that stores information associating the subject data stored in the nonvolatile memory with the selected background data in the nonvolatile memory.
